(19) United States
(12) Patent Application Publication
(10) Pub. No.: US 2014/0087026 A1
(43) Pub. Date: Mar. 27, 2014

(54) NOVEL FOOD COMPOSITION OF WHOLE PLANT CELLS

(71) Applicant: DianaPlantSciences, S.A.S., Rennes (FR)

(72) Inventors: Sung-Yong H. Yoon, Lake Oswego, OR (US); Marc Philouze, West Linn, OR (US)

(73) Assignee: DianaPlantSciences, S.A.S., Rennes (FR)

(21) Appl. No.: 14/037,080

(22) Filed: Sep. 25, 2013

Related U.S. Application Data
(60) Provisional application No. 61/706,006, filed on Sep. 26, 2012.

(51) Int. Cl. A23L 1/30

(52) U.S. Cl. CPC A23L 1/3002
USPC 426/61

(57) ABSTRACT

Novel food products and food ingredients include undifferentiated, heterotrophically produced plant cells. The undifferentiated plant cells are produced in cell culture and isolated from the media to form a plant cell food ingredient and/or mixed with other traditional food ingredients to make food products.

### CROSS-REFERENCE TO RELATED APPLICATIONS

This application claims the benefit of U.S. Provisional Patent Application Ser. No. 61/706,006, filed Sep. 26, 2012, which is hereby incorporated herein by reference in its entirety.

### BACKGROUND

1. The Field of the Invention

The present invention relates to undifferentiated, heterotrophically produced plant cells used in food products. The undifferentiated plant cells are produced in cell culture and isolated from the media to form a food ingredient and/or mixed with other food ingredients to make food products.

2. The Related Technology

Consumer interest in healthy eating is shifting towards the potential health benefits of specific foods and food ingredients. Moreover, scientific evidence supports the idea that some of these might have positive effects on our health and well-being, beyond the provision of basic nutritional requirements. There has been a growing interest in functional food development because of the beneficial health effects that it can promote. The rising demand on such foods can be typically explained by the increasing costs of healthcare, the steady enhancement in life expectancy, and the desire of older people to improve their health quality. Functional food was born as a new concept in Japan at the beginning of the 1980s, as a means to protect the health of the consumers and to reduce the high health costs derived from a high population with high life expectancies. The Food and Drug Administration (FDA) has accepted a correlation between some nutrients in the diet and the possibility to prevent several diseases. The drive to develop functional foods has arisen from the growing interest in the relationship between diet, specific food ingredients and health. Healthy eating can make a key contribution to health and well-being, but busy consumers may not have the time to access their optimal diet. Functional foods can provide health enhancing ingredients in a convenient form. As interest in the relationship between diet, health and well-being has grown substantially, there's a need for new high-valued functional foodstuffs that meet the human needs of nutrition, health benefits and prevention to disease.

Plants are irreplaceable food resources for humans. Synthetic chemicals and petroleum derivatives can replace some of plant-derived nutrients, but there is still no complete substitute for plant-derived foods. In order to maintain stable crop food supply, millions of acres of corn, soybeans, and other commodity crops have been grown with the help of heavy government subsidies. To grow these crops, industrial farms use massive amounts of synthetic fertilizers herbicides and pesticides, which deplete the soil and pollute the air and water. Chemical companies have sought government approval for genetically engineered crops designed to withstand heavy sprayings of herbicides and pesticides. In some cases, herbicides used in high amounts are no longer working—weeds are evolving into resistant, hard-to-kill “super-weeds.” One solution being pursued by some is to develop genetically engineered corn seed that is resistant to the herbicide 2,4-D, an ingredient in Agent Orange, the compound used to defoliate forests and croplands during the Vietnam War. One concern with this approach is Agent Orange's link to lymphoma and other cancers. Accordingly, during the last decade, consumers' have become increasingly concerned about the source and quality of food. Several food scandals (e.g. BSE, dioxins, bacterial contamination) have also contributed to these concerns. Consumers have started to look for safer and better controlled foods produced in more environmentally friendly, authentic and local systems. The vast majority of human populations consume plants including vegetables and fruits, the notable exception being the inhabitants of arctic regions, at least before the introduction of vegetables processed by methods allowing their preservation. Plants represent a major portion of our diet, both quantitatively and qualitatively. Three to four hundred grams per day are recommended for adults and variety is strongly recommended, since in addition to providing a wide range of taste sensations, different vegetables represent very different nutritional assets, depending on their type, colour and size. Mineral and vitamin contents may vary by a factor of ten and certain valuable substances are peculiar to specific varieties or strains within a vegetable species. Many health organizations, such as the American Cancer Society, American Heart Association and the American Diabetes association all recommend eating lots of vegetables and fruits.

However, as this healthy push towards increasing consumption of fruits and vegetables and decreasing consumption of refined and processed foods there is a growing concern about regarding low level pesticide and herbicide exposure from chemical residues left on produce. The use of pesticides and herbicides on fruit and vegetables over the last 60 years farmers and growers have changed the way they produce food in order to meet the expectations of consumers, supermarkets and governments. In doing so they have made many changes to the way they farm.

Pesticide toxicity threatens US consumers in the “circle of poison” effect in which unregistered or banned pesticides are exported to other countries such as Mexico and sprayed on crops whose produce is then exported back to the US. Mexico has increased its reliance on pesticide imports and is currently the second largest pesticide importer in Latin America. New Zealand pesticide use has also continued to increase with New Zealand continuing to rely heavily on pesticide use in its farming practices. Additionally many European countries also export banned pesticides to many nations that export produce to the US and find their way to US grocery stores and subsequently into US homes for consumption. Homegrown fruits and vegetables may not be much better. A report card for pesticide regulation issued by Consumers Union in 2001 gave the U.S. Environmental Protection Agency a grade of D for reducing dietary risks associated with pesticide residues on foods grown in the U.S., citing “slow progress, and much of the task incomplete.”

Currently, US Food and Drug Administration (FDA) is responsible for protecting the public health by assuring the safety, efficacy, and security of the food supply in the United States, including imported foods. FDA tests on imported foods reveal that contamination by illegal pesticides account for only five percent of imports (other independent testing suggest contamination rates slightly higher); however, contamination rates are higher for imported carrots, pineapples, rice, peas and pears. Of important note however, is the FDA is understaffed and only tests one or two percent of imports while the rest wind up in US grocery stores. About 1.3 million tons of pesticides are used in the U.S. each year, giving an average of 6 pounds of pesticides for every acre planted.

Safety tests are required to determine the potential of a pesticide to cause chronic illness in humans. Unfortunately, sufficient data on the reproductive effects and other chronic effects are lacking for most pesticides. Less than 21% of all pesticides sold in U.S. have been adequately tested for carcinogenicity. Less than 10% have been adequately tested for their ability to cause genetic mutations, and less than 40% have been adequately tested for their potential to cause birth defects. In 1978 Congress mandated the EPA to begin reassessing the safety of some 35,000 registered pesticide products, but a lack of funds has seriously delayed the process so that many of the registered pesticides remain unevaluated. At present, there are forty-five pesticides approved for food use that are known or suspected to cause cancer in animals, but it is uncertain at this time whether they are harmful to humans. For the average consumer there is little data available on dietary exposure to a particular pesticide over a period of time, making it very difficult to link pesticide exposure with a specific health problem.

There are a number of reports of adverse reproductive and developmental effects in wildlife resulting from heavy exposure to pesticides, PCBs, dioxins and other environmental contaminants. People exposed through their work, such as farm workers and other persons handling pesticides and herbicides, face the greatest risk. For example, leukemia and cancers of the lymphatic system are more common among workers who for many years have applied phenoxyherbicides along railroads, electrical lines or in agricultural settings. Lung cancer rates are elevated among pesticide applicators while liver cancer and leukemia rates are elevated among farm workers. The incidence of lymphatic, genital and digestive tract cancers correlates with a higher than average herbicide use. Recent studies in Germany show a link between heavy pesticide use in rural areas and incidence of childhood leukemia. Pesticides, along with PCBs, dioxin and other environmental contaminants may act as endocrine disrupters—interfering with hormonal action and body functions. This makes them possible risk factors for hormone-related cancers such as prostate and breast cancer. Recent studies by the National Cancer Institute in Hawaii suggest that repeated exposure to the endocrine-disrupting chemicals, chlordane/heptachlor and 1,2-dibromo-3-chloropropane, may play a role in the development of breast cancer. Strawberries, cherries, apples, Mexican cantaloupe, Chilean grapes, raspberries, apricots, peas, peaches, nectarines, and spinach. The least contaminated with pesticides include avocados, onions, scallions, corn, cauliflower, cabbage, broccoli, green peas, carrots, sweet potatoes, and blueberries. Pesticides tend to accumulate in fatty material. Hence fatty meats, fish, and dairy products will have higher pesticide residue than the low-fat products. The wax coating on cucumbers facilitates the retention of the fungicides used on cucumbers

Every year the Environmental Working Group (EWG, http://www.ewg.org), a not-for-profit environmental research organization, releases a list of fruits and vegetables that are most and least contaminated with pesticide residues. By eating some of the most contaminated fruits and vegetables, you and your children are exposed to about 10 different pesticides a day, according to EWG. Table 1 shows the most contaminated fruits and vegetables in 2012.

TABLE 1

| Rank | Vegetables/Fruits |
|---|---|
| 1 | Apples |
| 2 | Celery |
| 3 | Sweet bell |
| | peppers |
| 4 | Peaches |
| 5 | Strawberries |
| 6 | Nectarines |
| 7 | Grapes |
| 8 | Spinach |
| 9 | Lettuce |
| 10 | Cucumbers |
| 11 | Blueberries |
| 12 | Potatoes |
| 13 | Green beans |
| 14 | Kale |

Another issue for the current food industry is genetically engineered foods, are prevalent in human diet today. In the US alone, over 80% of all processed foods contain genetically modified foods. Other modified foods include grains such as rice, corn and wheat; legumes such as soybeans and soy products; vegetable oils, soft drinks; salad dressings; vegetables and fruits; dairy products including eggs; meat, chicken, pork and other animal products. Even infant formula includes such products. In addition, a vast array of hidden additives and ingredients exist in processed foods (such as tomato sauce, ice cream, margarine and peanut butter). Consumers often do not know they are consuming these products because labeling is not required and may even be prohibited. Independently conducted studies show a correlation between increased consumption of genetically modified foods and increased harm to health. The use of these genetically modified products is akin to an uncontrolled, unregulated mass human experiment, the results of which are unknown. It may take years to learn the risks and consequences of using genetically modified products. When the risks are known it may be too late to reverse damage that a growing numbers of independent experts believe exists. Once GM seeds are introduced to an area, it may be difficult or impossible to eradicate these new strains.

Some types of GM corn and cotton are engineered to produce their own built-in pesticide in every cell. Biotech companies claim that the pesticide, called Bt—produced from soil bacteria Bacillus thuringiensishas—a history of safe use, since organic farmers and others use Bt bacteria spray for natural insect control. Genetic engineers insert Bt genes into corn and cotton, so the plants do the killing. The Bt-toxin produced in GM plants, however, is thousands of times more concentrated than natural Bt spray, is designed to be more toxic, has properties of an allergen, and unlike the spray, cannot be washed off the plant. Moreover, GM foods are designed to produce toxins. GM soy and corn each contain two new proteins with allergenic properties, GM soy has up to seven times more trypsin inhibitor—a known soy allergen, and skin prick tests show some people react to GM, but not to non-GM soy. Soon after GM soy was introduced to the UK, soy allergies skyrocketed by 50%. Some have suspected that the US epidemic of food allergies and asthma is a casualty of genetic manipulation or may be exacerbated by genetic manipulation.

Despite the unprecedented role synthetic nitrogen fertilizers have played in increasing agricultural crop and livestock production and meeting the nutritional requirements of a growing human population, strong evidence has emerged demonstrating the detrimental effects of the increasing amounts of reactive nitrogen in the environment. Among the deleterious effects of excessive environmental nitrogen are acidification of soils and water resources, eutrophication of coastal marine ecosystems, loss of biodiversity in terrestrial and aquatic ecosystems and invasion of nitrogen-loving weeds, increased greenhouse gas levels due to emissions of N₂O, depletion of stratospheric ozone, increased ozone-induced injury to crop, forest and other ecosystems, and increased atmospheric haze and production of airborne particulate matter. Evidence exists in various places that fertilizer nitrogen residues are at least partially responsible for the nuisance algal growth in the eutrophication process that degrades surface waters. Furthermore, any quantity of nitrate-nitrogen that may accumulate from fertilizer source in ground and surface waters is a major portability determinant for man and animal, being responsible for the malady of methemoglobinaemia in infants. An example of the severity of excessive reactive nitrogen in the environment is that over 60% of coastal rivers and bays in the US have been moderately or severely degraded by nutrient pollution, especially by nitrogen.

Recently, organically grown food is viewed as a more environmentally friendly method for growing and producing agricultural products. There seems to be a great deal of common sense behind this; growing food that is free of the pesticides, hormones, and petroleum-based fertilizers that industrial agriculture commonly uses sounds like a much “greener” way to produce food. The greatest problem with organic food is that it is a highly inefficient process. Organic farming produces less food and requires twice the acreage to produce the same crop as modern farming techniques, which goes against the environmentalist ideas of opposing deforestation and trying to reduce the amount of land human beings use. If the world fully switched to organic agriculture, it would use twice the amount of land to produce the same amount of food as modern farming. Organic food isn't actually any safer, due to the high amount of manure used as a fertilizer, which results in a greater risk of contamination.

In 2006 there were two major outbreaks of E. coli that both resulted in death and illness; both were traced back to organically grown spinach and lettuce. While organic foods make up only 1% of food sold in the US, they account for 8% of our E. coli cases. The large quantities of manure used on organic crops also has a negative impact on our rivers and oceans. One of the biggest problems with agriculture is that runoff from fertilizer into the ocean increases the nitrate levels in the water, leading to algae blooms that absorb nutrients and lead to massive ‘dead zones’ in the ocean. Organic farming can provide relatively higher and safer quality of food ingredients, but it probably is not a permanent solution to the problems of modern agricultural production.

Another disadvantage of traditional food production, agriculture is highly dependent on specific climate conditions. Crops grown in the United States are critical for the food supply around the world. U.S. exports supply more than 30% of all wheat, corn, and rice on the global market. Changes in temperature, amount of carbon dioxide (CO₂), and the frequency and intensity of extreme weather could have significant impacts on crop yields. Warmer temperatures may make many crops grow more quickly, but warmer temperatures could also reduce yields. Crops tend to grow faster in warmer conditions. However, for some crops (such as grains), faster growth reduces the amount of time that seeds have to grow and mature, which can reduce yields. Climate change also impacts agricultural practices in the world through more frequent water shortages, extreme weather events, flooding, and shifts in growing seasons and food production will vary by region. In some places, warmer temperatures may extend the growing season, while in other regions more heavy downpours may increase crop losses. Regardless of whether shifts in climate are ultimately beneficial or harmful, the agricultural industry will have to modify certain practices to adapt to new conditions as a result of anticipated changes in weather patterns.

These and other problems in producing nutrition to the increasing human population demonstrate a long felt but unmet need to produce high quality, safe foods while minimizing damage to the environment.

### DESCRIPTION

The present invention includes food products, food ingredients, and methods for making food products and/or ingredients that include whole cell, undifferentiated, heterotrophically grown plant cells from cell culture. The whole cell, heterotrophically grown plant cells are derived from one or more of numerous genera and species of edible plants having nutritionally bioactive plant cell ingredients and functional activity useful for promoting public health. The novel whole plant cell-derived foods can be produced free of herbicide, fungicide and plant toxins with desired levels of nutrients and bioactives, which can improve human nutrition.

Plant cell culture has been used previously to produce a wide range of chemical compounds and nutrients used in foods, such as flavors, colorants, essentials oils, sweeteners, antioxidants, and nutraceuticals. Using these known methods, manufacturers grow the plant cells heterotrophically and then extract the chemical compounds or nutrients from the cells. In contrast, the present invention relates to heterotrophic production of plant cells for use as whole cells in food products. Rather than extract nutrients from the cells, the whole cells of the present invention are processed to make the cells suitable for use as an ingredient in food products. The heterotrophic plant cells may be harvested, washed, dried, and/or pasteurized to produce a food ingredient or food product suitable for human consumption.

The processed undifferentiated whole cells described herein have surprisingly been found to produce appetizing a aesthetically pleasing food products. Indeed, Applicant has found that the undifferentiated whole cells can have similar properties as some traditional cooking ingredients such as wheat flour. The dried, undifferentiated whole cell plant ingredients can be substituted for traditional flour ingredients in baked goods to produce foods with similar properties of traditional food, including similar appearance and taste.

The ability to use the undifferentiated cells without extraction is a substantial improvement over the prior art. The use of whole cells in foods improves nutritional value because the whole cells have a complex assortment of nutritional components, some of which are in trace amounts. When compounds are extracted, trace components are lost and are not included in the food because their importance is not yet known. In addition, the whole cells produced in plant culture can be optimized to produce nutrients that are lacking in other foods and thereby produce an overall food product with the highest optimal nutrient composition possible. The high nutrient cells can offset the lack of nutrient caused by many modern agricultural practices. In addition to nutrient, the undifferentiated plant cells can be cultured to produce pigments or flavorings that are lost or under expressed in foods produced using modern agricultural techniques.

The use of whole cells can also benefit the environment by allowing high nutrient high value ingredients to be produced with minimal land use and without the production of large volumes of wasted plant mass. Many high nutritional value food ingredients require growing plants for which the vast majority of the plant is unusable. This wasted plant matter is a cost to the grower and the environment. By culturing just the plant cells, the nutrition can be obtained without the energy cost or land use cost of the unused plant matter.

### Methods for Manufacturing Heterotrophic Plant Cells for Use in Food Products

The methods of the invention generally include all or a portion of the following steps: (i) providing a cell culture and bioreactor, (ii) selecting a heterotrophic plant cell line, (iii) propagating and harvesting the plant cells, (iv) drying and pasteurizing the heterotrophic plant cells, and (v) final processing (e.g., milling, extrusion, or flaking).

(i) Providing a Cell Culture and Bioreactor

Recent advances in cell culture have allowed plant cells to be grown in large volumes in bioreactors. The particular cell culture medium used will depend on the particular cell line being employed. The cell culture medium includes a hydrocarbon (e.g., carbohydrate) source of energy and nutrients and/or growth factors needed to propagate the cells. Several strategies can be applied to boost the yield of targeted metabolites at the cell suspension stage. For example, the nutrient medium can be optimized using techniques known in the art of microbial biotechnology. Usually the medium composition is modified with respect to the concentrations and/or ratios of main nutrients (carbon, nitrogen, and phosphorous sources). Other techniques include exploiting natural processes, namely, the specific plant's response cascades to stress factors, to improve yields and productivities of plant cell cultures. Elicitors include chemicals (inter alia metal ions and various compounds) and biofactors (including microorganisms, herbivores, and plant cell wall components) that can induce physiological changes in the target living organism and hence the plant cells derived from those organisms.

The cell culture medium is used to heterotrophically propagate plant cells in a bioreactor. The bioreactor provides a controlled environment with controlled temperature, nutrient content, feed rate, etc, which allows for minimal or no pesticides or herbicides to be added. In addition, by growing the plant cells in a bioreactor, contamination of soil and the environment is avoided.

The bioreactor can be one or more of several different types, including, but not limited to stirred tank reactors, airlift reactors, and bubble column reactors, and similar type reactors used in microbial biotechnology. The bioreactor may be a disposable bioreactor such as, but not limited to a so-called life reactor, ebb- and flow-bioreactor, plastic-lined bioreactor, or wave reactor.

The bioreactor may be operated as a continuous process or as a batch process. The bioreactors may be stand-alone reactors or cascade reactors with increasing volume from one reactor to the next. Cascade reactors may be at least 2, 3, 4, 5 or more in line reactors with increasing volumes downstream.

The size of the reactor can be important in order to produce sufficient quantities useful in food products. In one embodiment, the reactor volume is at least 100 liters, 1,000 liters, or even at least 10,000 liters. Bioreactors greater than 10,000 liters are typically operated in a cascade.

In some embodiments, the culture medium may be sterile or include a number of components that are sterile such microbial growth other than the selected plant culture is minimal or eliminated.

(ii) Cultivars

The particular plant cells (i.e., cultivars) used in the methods of the invention are cells that can be propagated in a cell culture medium in a bioreactor (also referred to herein as heterotrophic plant cells). The heterotrophic plant cells are selected for their nutritional value, taste, and ease of growth in a bioreactor. Heterotrophic plant cells include grain cells, vegetable cells, fruit cells, pigment-producing cells, flavor-producing cells, and fragrance-producing cells that are suitable for cell culture in a bioreactor.

Examples of varieties of heterotrophic plant cells that can be used include a grain selected from oat, quinoa, millet, teff, buckwheat, sunflower, Jerusalem artichoke, barley, rice, rye, sorghum, wheat, spelt, emmer, einkorn, kamut, maize; a vegetable selected from garlic, onion, celery, asparagus, beet, cabbage, broccoli, kale, cauliflower, canola, mustard, pepper, chicory, cucumber, squash, carrot, yam, sweet potato, lettuce, lentil, tomato, avocado, legumes, mustard, potato, spinach; and/or a fruit selected from pineapple, tea, papaya, carob, orange, grapefruit, lemon, lime, coconut, coffee, melon, fig, Strawberry, apple, mango, banana, plantain, date, peach, cherry, almond, plum, pear, raspberry, blackberry, cocoa, berry, and/or grape.

Where the heterotrophic plant cell is selected to include a flavor, fragrance, or colorant type of plant cell may be annatto, tea, cinnamon, saffron, turmeric, palm, hops, lavender, mint, basil, oregano, marjoram, parsley, rose, rosemary, sugar, sage, thyme, vanilla.

Examples of particular species of cells that can be used in the present invention include, but are not limited to Avena sativa, Chenopodium spp., Echinochloa spp., Pennisetum spp., Setaria spp., Panicum spp., Eleusine spp., Paspalum spp., Eragrostis tef Fagopyrum esculentum, Helianthus sp., Oryza spp., Secale cereal, Sorghum spp., Triticum spp., Zea mays, Allium spp., Apium graveolens, Asparagus officinalis, Beta vulgaris, Brassica spp., Capsicum spp., Piper spp., Pimenta spp., Cichorium intybus, Cucumis sativus, Cucurbita spp., Daucus carona, Dioscorea sp., Ipomoea sp., Lactuca sativa, Lens culinaris, Lycopersicon spp., Persea americana, Phaseolus spp., Vigna spp., Glycine max, Arachis hypogaea, Pisum spp., Sinapis alba, Solanum tuberosum, Spinacia oleracea, Ananas comosus, Camellia sinensis, Carica papaya, Ceratonia siliqua, Citrus sp., Cocos nucifera, Coffea spp., Cucumis spp., Ficus spp., Fragaria spp., Malus domestica, Mangifera spp., Musa spp., Phoenix dactylifera, Prunus spp., Pyrus spp., Rubus spp., Theobroma cacao, Vaccinium spp, Viburnum spp., Vitis spp., Bixa orellana, Camellia sinesis, Cinnamomum spp., Crocus Sativus, Curcuma longa, Elaeis guineensis, Humulus lupulus, lavandula spp., Mentha spp., Ocium basilicum, Origanum spp., Petroselinum spp., Rosa spp., Rosmarinus officinalis, Saccharum spp., Beta vulgaris, Salvia spp., Thymus spp., or Vanilla spp.

(iii) Propagating and Harvesting the Heterotrophic Plant Cells

The selected plant or cultivar is propagated heterotrophically in the culture medium to produce whole cells that have particular desired levels of nutrients or other cell components when combined with a food material. The cells are typically propagated with agitation and aeration to ensure availability of nutrients and to remove volatile compounds produced during growth.

Although not required, the propagated cells will typically have an increased concentration of a desired nutrient as compared to the native plant tissue from which the heterotrophic plant cells was derived. The desired nutrient of increased concentration may be an amino acid, mineral, vitamin, flavoring, fragrance, and/or pigment, etc. that is lacking in a food product. The cell culture media can be optimized to cause production of the desired nutrient by adjusting the cell culture medium and/or bioreactor conditions, as discussed herein, to cause the cells to produce larger quantities of the desired nutrients.

Since the whole cells are typically used in the food products, it can be important to select conditions that produce a product that will improve the taste or maintain an acceptable taste of the finished product. The nutrients, bioreactor conditions, growth media components, and growth factors used in the propagation stage can affect the taste and content of the whole cells.

The propagated cells are harvested by separating them from the culture media. The cells can be separated using techniques known in the art. For example, the cells can be dewatered and/or washed using known techniques. For example, the cells can be pressed (e.g., on a screen or in a screw press) to reduce the water content. If desired, the media can be washed from the cells. Washing the cells can remove non-cellular components that may affect the taste, quality, longevity, and/or suitability of the cells as a food component. The washed plant cells may be substantially free from culture media. Cultured plant cells that are substantially free of culture media lack the taste associated with culture media.

(iv) Drying and Pasteurizing

Following harvesting, the heterotrophic plant cells may be dried to preserve the cells, and allow them to be stored, used, or processed. The drying process can be done in dryers suitable for making food grade products. For example, the heterotrophic plant cells may be dried in a drum dryer, rotary dryer, lyophilizer or other freeze dryer.

The drying can be carried out to produce dried plant cells having a less than 25%, 20%, 15%, 10%, or 5% by weight and/or greater than 1% or 5% or within a range of the upper and lower moisture contents.

The drying process and/or additional steps may be used to pasteurize the heterotrophic plant cells. The pasteurizing process ensures that the cells are non-living and that the concentration of any potential pathogens is minimal. This allows the heterotrophic plant cells to be stored and/or mixed with other food components. The pasteurizing can be performed at low temperatures or high temperatures using known pasteurizing techniques.

(v) Finish Processing

The plant cells may be processed to produce a biomass having desired physical properties. For example, the cells can be process to produce a biomass with a desired particle size (i.e., surface area) and/or texture. The particle size and surface area of the finished product has a significant impact on its texture and wettability, both of which are important to food processing and taste. The plant cells may be milled to reduce particle size or be agglomerated to form flakes or other structures useful for storing or using the plant cells in a food product. The heterotrophic plant cells may be processed to form a dry biomass, flake, flour, or powder suitable for use with blending with other food components derived from cultivated plants or land-raised animals.

The particle size of the plant cell matter after harvesting depends on many factors including the type of plant cells grown, the type of bioreactor used, the type of cell culture media used, and/or the type of drying process used. In general, plant cells are typically bigger than microorganisms. Sizes of plant cells may be in a range from 40-200 μm. Many plant cells have one or more large, distinct vacuoles, which may occupy 90-95% of the cell volume. Nutrients and metabolites are generally stored in the vacuole. Another important feature of plant cells is their tendency to form aggregates, consisting of several hundred cells, in clumps of 0.5 cm diameter or more. In bioreactor cultivation, the cells/aggregates may settle out in less than 20 minutes after ending agitation and aeration.

Consequently, in some embodiments it may be desirable reduce the particle size of the heterotrophic plant cells. To produce a finished product of consistent texture and surface area, the cells may be milled to a desired particle size. The particle size of the plant cells may be milled to a median particle size less than 850 μm, 250 μm, 100 μm, 50 μm, or 10 μm, and/or greater than 0.5 μm, 1 μm, 10 μm, or 50 μm

Any type of milling suitable for food grade products may be used. An example of a suitable mill is a roller mill. To properly mill the plant cells, the water content may need to be sufficient low to prevent agglomeration. Suitable water content of the cells will depend on the ambient humidity, the desired particle size, the particular type of cells and the type of milling equipment being used.

If desired, the cells may also be agglomerated to produce a material with a lower surface area. Examples of suitable agglomerating techniques include extrusion or pressing to form flakes. Extrusion and flaking are generally performed at a higher moisture content compared to milling.

Although post-harvesting processing is typically highly advantageous to produce a desired texture and surface area some embodiments of the invention can utilize the plant cells as is and thus changing the particle size is not required.

### Food Ingredients

In one embodiment, the undifferentiated plant cells are processed as described above to form a food ingredient suitable for human consumption. The whole cell ingredients are substantially free of chemicals and microbes that cause disease or illness. (i.e., the whole cells can be consumed in quantities that are nourishing and filling without causing disease or illness). The food ingredient is substantially free of culture media (i.e., the cell culture does not have the taste of cell culture media). In a preferred embodiment, the cultured plant cells are a washed plant cell culture and therefore have substantially no residual cell culture and/or have most or all of the cell culture removed as compared to cultured cells that are not washed.

The food ingredient may be packaged and distributed to food manufacturers for use in food manufacturing or packaged and distributed to end users for home cooking or baking. The plant cell ingredient may be packaged in any suitable food grade packaging. Suitable materials include food grade plastic, paper, cardboard, aluminum, steel, or other suitable packaging material. The packaging may be labeled with as having food grade ingredients or as being compliant with a quality standard of a food safety agency or standard. The packaging may include nutrition information.

The food ingredient may be analyzed for safety as a human food product according to a governmental food safety agency (e.g., European Food Safety Authority, U.S. Department of Agriculture or U.S. Food and Drug Administration, or agencies in other countries that provide a similar food safety function).

Food Products incorporating Heterotrophic Plant Cells

The heterotrophic plant cells are used as an ingredient in making food products for human consumption. The heterotrophic plant cells provide added nutrients including vitamins, minerals, amino acids, flavors, fragrances, and/or pigments to the food products. However, since the nutrients are produced from living plant cells, the nutrients are natural nutrients, which tend to be healthier than other sources of added nutrient. The heterotrophic plant cells can be free of herbicides, pesticides, and chemicals used to treat soil grown plants or extract nutrients from plant sources. In addition, because the nutrients are grown in a plant cell and provided that way in the food, the nutrients in the plant cells of the present invention can have improved bioavailability (i.e., they are more readily incorporated into the body) as compared to processed nutrients.

The heterotrophic plant cells can be incorporated into any food product. Examples of types of foods into which the plant cells may be incorporated include diary, fruit, vegetable, meat, or dessert. The plant cells can be incorporated into raw cooking materials (e.g., flour) or added as a separate ingredient in making a finished food produced (e.g., a baked good). The food component can be of a variety of different types and forms. For example, plant cells may be combined with food component such as, but not limited to, pancakes, cookies, salad dressing, smoothie, milk, scones, chips, yogurt, cheese, vegetables, beans, eggs, bread, cereal, pasta, or flour in various different forms. In yet another embodiment, the heterotrophic cells may be incorporated into a nutritional supplement such as a health tablet.

The heterotrophic plant cells are typically mixed with a food component as a dry powder or granular biomass. For example, powdered plant cells can be mixed with flour or used as a flour in foods such as baked goods or mixed with drinks such as milk or juice or added to liquids or suspensions such as yogurt or incorporated into a pasta (e.g., extruded with the batter to make pasta). A ground or unground granular plant cell may be included in granola bar or cereal.

In some embodiments the food component may also include a powder or granular component. In some embodiments the median particle size of the food component may be less than 150 μm, 100 μm, 50 μm, or 10 μm and/or greater than 0.5 μm, 1 μm, or 5 μm, or within a range of the foregoing upper and lower sizes.

The heterotrophic plant cells may be intimately mixed with the food component as when combined with a flour or baked into a food product. Alternatively, the mixture of the plant cell and the food component maybe more macro. For example, plant cell flakes may be mixed with traditional flakes (e.g., corn flakes derived from cultivated corn).

The amount of the heterotrophic plant cells included in the food products may vary greatly. However, sufficient plant cell is included to have a significant impact on the nutrition or other desired property of the food product. In some embodiments, the amount of the heterotrophic plant cells is at least 1%, 5%, 10%, or 20% by weight and/or less than 80%, 50%, 30%, 15% or 5% by weight of the food product and/or within a range of the foregoing upper and lower values.

### EXAMPLES

### Example 1

### Manufacturing Process of Plant Cells

Various species of plant cells were cultivated in shake flasks or bioreactors with a goal to achieve sufficient biomass including nutrients of active small molecules (anthocyanin, polyphenol, flavan-3-ol, minerals, vitamins et al) and larger molecules (fiber, protein, lipid et al). The suspension culture media used in flasks were dependent on the plant species, but their basic compositions are as the below table. The culture was carried out under dark or light condition controlled at 20˜25±1° C. Cell suspensions are then scaled-up in suspension and the measurements are regularly taken to determine intracellular nutritional components. With batch or fed-batch operation mode for 7˜21 days of culture period, cells are then harvested and subsequently dried in a spray dryer or drum dryer or lyophilizer and stored in an airtight glass container at −20˜20° C. For biomass production of plant cells, GMP procedures are followed.

TABLE 2

| | | Inorganic | |
|---|---|---|---|
| Inorganic Salt | Concentration | Salt | Concentration |
| Ion | (mM) | Ion | (μM) |
| NH₄⁺ | 2.0~20.6 | I⁻ | 0.5~9.5 |
| K⁺ | 1.0~30.9 | Mn²⁺ | 0.3~198.0 |
| Mg²⁺ | 0.5~7.5 | Zn²⁺ | 0.7~150.0 |
| Ca²⁺ | 0.1~9.3 | B | 0.9~172.0 |
| Na⁺ | 0.1~3.2 | Mo | ≦5.2 |
| NO₃⁻ | 3.3~40.0 | Co²⁺ | 0.01~0.53 |
| PO₄³⁻ | 0.1~6.3 | Cu²⁺ | 0.01~2.0 |
| SO₄²⁻ | 0.9~12.3 | Ni²⁺ | 0.02~0.13 |
| Cl⁻ | 0.3~14.1 | Al³⁺ | 0.23~0.42 |
| | | Fe²⁺ | 3.7~200.0 |
| | Concentration | | Concentration |
| Vitamin | (mg/L) | Hormone | (mg/L) |
| Myo-inositol | ≦100.0 | Auxin | ≦10.0 |
| Thiamin-HCl | ≦10.0 | Cytokinin | ≦10.0 |
| Nicotinic acid | ≦1.0 | | |
| Pyridoxine-HCl | ≦2.0 | | |

| | Concentration |
|---|---|
| Carbohydrate | (g/L) |
| Sucrose | ≦100.0 |

### Example 2

### Nutritional Profiles

The full nutritional profiles of plant cell flours of Theobroma cacao and Vaccinium myrtillus are outlined in Table 3 & 4. Dried plant cells as food ingredient provided six basic nutrients for good health (carbohydrates, protein, fat, fiber, vitamins, and minerals) as well as various bioactive phytocompounds (phenolics, terpenes, alkaloids, nitrogen-containing or ogranosulfur compounds and phytosterols). For example, flavonoids can be protective of vascular systems and may have an overall beneficial effect on human health, decreasing the risk of chronic disease. Already 5000 different phytocompounds have been identified in fruits and vegetables. This examples describes the dried plant cells include balanced food ingredients of the basic nutrients and bioactive phytocompounds.

TABLE 3

| Theobroma | Per 100 gram of | | |
|---|---|---|---|
| cacao | dried plant cells | | % Daily Value |
| Calories | 410 | g | |
| Calories from fat | 30 | g | |
| Total Fat | 4 | g | 7 |
| Saturated Fat | 1.5 | g | 8 |
| Trans Fat | 0 | g | |
| Cholesterol | 0 | g | 0 |
| Sodium | 0 | g | 0 |
| Total | 75 | g | 25 |
| Carbohydrate | | | |
| Dietary Fiber | 26 | g | 100 |
| Sugars | 34 | g | |
| Protein | 18 | g | 37 |
| Vitamin A | 371 | IU | 7 |
| Vitamin C | 16 | mg | 26 |
| Calcium | 276 | mg | 27 |
| Iron | 7 | mg | 38 |
| Polyphenol | >25 | g | |

*Percent Daily Values are based on a 2,000 calories diet.

TABLE 4

| Vaccinium | Per 100 gram of | | |
|---|---|---|---|
| myrtillus | dried plant cells | | % Daily Value |
| Calories | 410 | g | |
| Calories from fat | 70 | g | |
| Total Fat | 8 | g | 13 |
| Saturated Fat | 2 | g | 11 |
| Trans Fat | 0 | g | |
| Cholesterol | 0 | g | 0 |
| Sodium | 40 | g | 2 |
| Total | 64 | g | 21 |
| Carbohydrate | | | |
| Dietary Fiber | 25 | g | 100 |
| Sugars | 18 | g | |
| Protein | 19 | g | 39 |
| Vitamin A | 0 | mg | 0 |
| Vitamin C | 13 | mg | 22 |
| Calcium | 203 | mg | 20 |
| Iron | 15 | mg | 81 |
| Polyphenol | >20 | g | |

*Percent Daily Values are based on a 2,000 calories diet.

### Example 3

### Production of Plant Cell Powder

To process plant cell biomass to plant cell powder, the harvested plant cell biomass was separated from the culture medium using centrifugation and dried using a spray dryer or freeze-dryer according to standard methods. The resulting dehydrated plant cell powder (dried whole cells) was packaged and stored until use.

### Example 4

### Production of Plant Cell Flakes

The dried, ground plant cell biomass of Theobroma cacao is tumble toasted for 30 seconds in cylindrical ovens. The air in the ovens is heated by using an air temperature of 600° C. where gas flame is the heat source. The flakes are tossed around in a rotating drum. The flakes are then sprayed with Theobroma cacao extracts, vitamins and minerals to further enhance their nutrition content and are mixed with corn flakes or other cereal flakes before packaging.

### Example 5

### Production of Plant Cell Flour

The plant cell powder was milled using a homogenizer until the average particle size of the biomass was 100 μm in average. The resulting dehydrated plant cell flour (dried homogenized whole cells) was packaged and stored until use.

### Example 6

### Cardio/Metabolic Tablets (Encapsulated/Tablet-Form)

The ingredients of the metabolic health tablet (1.25 g size) consisted of dried plant cell biomass of Theobroma cacao (over 20% polyphenol dry cell weight) (1000 mg/tablet), vitamin C as ascorbic acid (250 mg/tablet), and bioperine (bioavailability enhancer from Piper nigrum) (2.5 mg/tablet).

### Example 7

### Weight Management Smoothie

The ingredients of the fruit-based smoothie includes distilled water (815.365 g), stabilizer (4.5 g), apple juice concentrate (58 g), orange juice concentrate (46.376 g), lemon juice concentrate (1.913 g), mango puree concentrate (42.5 g), banana puree (40.656 g), passionfruit juice concentrate (8.4 g), ascorbic acid (0.320 g), Vaccinium myrtillus cell flakes (20.0 g), Brassica oleracea cell flakes (20.0 g), orange flavor extract (1 g), pineapple flavor (0.4 g) and mango flavor (0.16 g). The ingredients were combined and blended until smooth.

### Example 8

### Pasta

This example describes a cooking procedure of pasta made by a whole cell biomass/flakes of Theobroma cacao, Vaccinium myrtillus, Crocus sativus and Brassica oleracea. In a medium sized bowl, combine flour and salt. Make a well in the flour, add the slightly beaten egg, and mix. Mixture forms stiff dough. If needed, 1 to 2 tablespoons water can be stirred in. On a lightly floured surface, dough is kneaded for about 3 to 4 minutes. With a pasta machine or by hand dough is rolled or extruded to desired thinness. A machine or knife is used to cut into strips of desired width.

TABLE 5

| Component | Weight (g) | Percent (%) |
|---|---|---|
| Brassica oleracea plant cell flakes | 35.3 | 13.7 |
| Vaccinium myrtillus plant cell powder | 85.4 | 33.2 |
| Crocus sativus plant cell powder | 12.8 | 5.0 |
| Salt | 3.5 | 1.4 |
| All-purpose flour | 40.0 | 15.6 |
| water | 80.0 | 31.1 |
| | 257.0 | 100.0 |

### Example 9

### Nutritional Energy Bar

The following example describes an energy bar recipe comprising three different plant cell powders instead of whole-wheat flour. The cooking procedure included (1) preheat the oven to 350° F., (2) coat a 9×13-inch baking pan with cooking spray, (3) place all ingredients except the syrup and eggs in a good processor and pulse until the mixture is finely chopped, (4) add the syrup and eggs and pulse until the mixture is well combined, (5) transfer to the baking pan and spread evenly, (6) bake for 20 minutes and cut into 20 squares.

TABLE 6

| Component | Weight (g) | Percent (%) |
|---|---|---|
| Brassica oleracea plant cell powder | 12.0 | 1.6 |
| Vaccinium myrtillus plant cell powder | 42.0 | 5.5 |
| Theobroam cacao plant cell powder | 42.0 | 5.5 |
| Rolled oats | 90.0 | 11.9 |
| Raw unsalted sunflower seeds | 42.0 | 5.5 |
| Toasted wheat germs | 57.5 | 7.6 |
| Dried apricots | 226.5 | 29.9 |
| Raw almonds | 95.5 | 12.6 |
| Raisins | 72.0 | 9.5 |
| Pitted dried dates | 42.0 | 5.5 |
| Powdered nonfat dry milk | 34.0 | 4.5 |
| Ground cinnamon | 1.3 | 0.2 |
| Maple syrup | 12.0 | 1.6 |
| Large eggs | 42.0 | 5.5 |
| | 756.8 | 100.0 |

### Example 10

### Salad Dressing

This example describes salad dressing using plant cell powder. Its preparation procedure is was: (1) Beat the vinegar in a bowl with the plant cell powder, sugar, garlic, salt and pepper until sugar and salt dissolves. (2) Beat in the oil by droplets, whisking constantly. (Or place all the ingredients in a screw-top jar and shake to combine.) (3) Taste and adjust the seasonings. (4) Toss a few tablespoons of the dressing with the salad mix and desired salad ingredients, top with blue cheese and serve immediately.

TABLE 7

| Component | Weight (g) | Percent (%) |
|---|---|---|
| Brassica oleracea plant cell powder | 3.0 | 0.9 |
| Vaccinium myrtillus plant cell powder | 3.0 | 0.9 |
| Theobroam cacao plant cell powder | 3.0 | 0.9 |
| Crocus sativus plant cell powder | 1.5 | 0.5 |
| Daucus carota plant cell powder | 3.0 | 0.9 |
| Balsamic vinegar | 63.8 | 19.9 |
| Dark brown sugar | 9.2 | 2.9 |
| Chopped garlic | 15.0 | 4.7 |
| Black pepper | 1.0 | 0.3 |
| Olive oil | 218.7 | 68.1 |
| | 321.2 | 100.0 |

### Example 11

### Snack Chips

The ingredients of the plant cell snack chips consisted of unbleached white flour (1 cup), potato flour (½ cup), Brassica oleracea plant cell powder (over 10% anthocyanin dry cell weight) (1 tablespoons), Theobroma cacao plant cell powder (over 20% polyphenol dry cell weight) (2 tablespoons), salt (¾ teaspoon, adjust to taste), barley flour (2 tablespoons), water (⅓-1 cup), and seasonings (e.g., cumin, curry, ranch dressing) (to taste).

Preparation procedure: The dry ingredients were mixed and ⅓ cup of water was added to the dry ingredients. Additional water was added (up to 1 cup total) to form dough. The dough was kneaded into a uniformed product and then allowed to rest for 30 minutes at room temperature. The rested dough was cut and formed into thin chips and baked at 275° F. for 20-30 minutes, or until crispy.

### Example 12

### Pancake

The addition of plant cell flour improved the texture and mouthfeel of the pancakes with basic pancake ingredients. Polyphenol from plant cell flour of Theobroma cacao and Vaccinium myrtillus were fortified in the ingredients and the pancakes were nutritionally superior.

TABLE 8

| Component | Weight (g) | Percent (%) |
|---|---|---|
| Theobroma cacao plant cell flour | 92.0 | 22.4 |
| Vaccinium myrtillus plant cell flour | 92.0 | 22.4 |
| Milk | 96.0 | 23.4 |
| White vinegar | 10.0 | 2.4 |
| All-purpose wheat flour | 40.0 | 9.8 |
| White sugar | 10.0 | 2.4 |
| Baking powder | 10.0 | 2.4 |
| Baking soda | 5.0 | 1.2 |
| Salt | 5.0 | 1.2 |
| Egg | 50.0 | 12.2 |
| Butter | 10.0 | 22.4 |
| | 410.0 | 100.0 |

### Example 13

### Gluten-Free Bread

A bread loaf pan was greased and a bowl was placed on a scale. Each dry ingredients into bowl and weighed and the dry ingredients in a mixing bowl were thoroughly blended. The eggs, olive oil and vinegar were blended in a large bowl and then 1 cup of water was added to the egg mixture. The mixed dry ingredients were slowly combined with the egg mixture. The remaining water was added slowly and the rest of dry ingredients were then added and mixed until the batter was the consistency of a thick cake batter. This batter was then mixed at high speed for approximately 5 minutes. The batter was then poured into the bread loaf pan and covered and let rise in a warm location for 1 hour. The dough was then baked for 55-60 minutes in a pre-heated 375° F. (190° C.) oven. Tenting with foil after 15 minutes was performed to prevent over-browning of crust. The bread was then removed immediately from the oven and cooled completely on a wire rack before cutting. The gluten-free bread had the appearance and texture of a conventional bread loaf. This demonstrates the successful use of the plant cell flour in a gluten-free yeast dough application.

TABLE 9

| Component | Weight (g) | Percent (%) |
|---|---|---|
| Theobroma cacao plant cell flour | 135.0 | 15.5 |
| Vaccinium myrtillus plant cell flour | 145.0 | 11.5 |
| Tapioca starch | 100.0 | 16.6 |
| Baker's yeast | 20.0 | 2.3 |
| Cane sugar | 25.0 | 2.9 |
| Salt | 11.0 | 1.3 |
| Guar gum | 3.0 | 0.3 |
| Xanthan gum | 2.0 | 0.2 |
| Ground ginger | 1.3 | 0.1 |
| Large egg whites | 114.0 | 13.1 |
| Light olive oil | 25.0 | 2.9 |
| Apple cider vinegar | 5.0 | 0.6 |
| Lukewarm water | 286 | 32.8 |
| | 872.3 | 100.0 |

### Example 14

### Chocolate Chip Cookie

The ability of the plant cell flour to function in a cookie application was tested using a chocolate chip cookie made with plant cell flour. The cooking procedure was as followed; (1) Preheat oven to 350° F. In a bowl, combine all-purpose flour, plant cell flour, baking soda, baking powder and salt. Set aside. (2) Butter/Milk/plant cell flour with brown sugar until smooth. Beat in egg and vanilla. (3) Gradually add in dry ingredients and mix until it just forms a dough. Fold in chocolate chips. (4) Take tablespoons of dough; drop onto cookie sheet or roll into balls and place onto cookie sheet. (5) Bake for 16-18 minutes or until golden brown, rotate cookie sheet half-way through baking

TABLE 10

| Component | Weight (g) | Percent (%) |
|---|---|---|
| Vaccinium myrtillus plant cell flour | 100.0 | 14.0 |
| All-purpose wheat flour | 56.3 | 7.9 |
| Milk, non-fat | 80.0 | 11.2 |
| Brown sugar | 100.0 | 14.0 |
| Baking soda | 2.4 | 0.3 |
| Salt | 2.9 | 0.4 |
| Large Egg | 50 | 7.0 |
| Butter | 113.4 | 15.9 |
| Vanilla extract | 26.0 | 3.6 |
| Chocolate chip | 182.4 | 25.6 |
| | 713.4 | 100.0 |

### Example 15

### Cranberry Cabbage Scones

The ability of the plant cell flour to function in a bread application was tested using scones made with plant cell flour and wheat flour. The cooking procedure was as followed; (1) Preheat oven to 400° F. Line baking sheet with parchment paper. Sift plant cell flour, wheat flour, sugar, baking powder, salt and baking soda into large bowl. Mix in orange juice. Add butter and rub in with fingertips until mixture resembles coarse meal. Mix in dried cranberries. Gradually add butter and sour cream, tossing with fork until moist clumps form. Turn dough out onto lightly floured work surface. Knead briefly to bind dough, about 4 turns. Form dough into 1-inch-thick round. Cut into 8 wedges. Transfer wedges to prepared baking sheet, spacing 2 inches apart. Bake until tops of scones are golden brown, about 25 minutes. Let stand on baking sheet 10 minutes. Scones can be served warm or at room temperature. The Scones produced using the method of Example 15 produced a food product of similar appearance of scones produced using wheat flour without the use of undifferentiated plant cell. The scones were appetizing and delectable.

TABLE 11

| Component | Weight (g) | Percent (%) |
|---|---|---|
| Brassica oleacea plant cell flour | 100.0 | 10.0 |
| Vaccinium myrtillus plant cell flour | 100.0 | 10.0 |
| All-purpose wheat flour | 50.0 | 5.0 |
| Sugar | 165.0 | 16.5 |
| Baking powder | 6.0 | 0.6 |
| Salt | 5.8 | 0.6 |
| Dried cranberries | 120 | 12.0 |
| Butter | 226.8 | 22.7 |
| Large egg | 100 | 10.0 |
| Sour cream | 115.0 | 11.5 |
| Orange juice | 9.0 | 0.9 |
| | 997.6 | 100.0 |

The present inventions can provide significant advantages over traditional methods of producing food products. Firstly, the process operation is running in controlled environment, independently from climatic and soil conditions. Secondly, negative biological influences that affect nutrition production in the nature are eliminated (microorganisms and insects). Thirdly automation of cell growth control and metabolic processes regulation, can decrease cost production and increase production rates. The present invention provides a less exhaustible source of nutrients.

The plant cells used in the food products of the invention may be selected and cultured on an industrial scale in sterile bioreactors, which effectively serve as “nurseries” of the desired plant substances, thus offering numerous advantages with respect to cultivation of plants in the open field. First and foremost, toxic substances such as herbicides, pesticides, heavy metals and other environmental culture may be grown in sterile antibiotic-free conditions. Moreover, the strict control of the culture conditions and the continuous selection activity considerably reduce the appearance of spontaneous variation, and guarantee a reproducible profile of primary and secondary metabolites, thereby overcoming the issue of variability linked to climatic and geographical conditions.

Furthermore, this technology obviates obstacles such as the natural biological cycle of the plant and the seasonality of the secondary metabolites, thereby providing full availability of the constituents at all times. In addition, the degradation of bioactive ingredients that usually occurs during storage of the plant material is greatly reduced as extraction is performed immediately following completion of the fermentation cycle, with minimal loss of the substances responsible for the beneficial properties of the extracts. The final result is thus the production of plant ingredients by rapid and flexible means, with no limitations on quantity, and with a greatly improved safety profile and a highly standardized composition. Moreover, this biotechnological process has a lower environmental impact than other conventional extraction methodologies, as neither massive harvesting of plant matter nor intensive exploitation of the land, especially critical in the case of slow-growing or protected species, are necessary.

Finally, as the plant biomass obtained via bioreactor culture has a very simple and homogeneous composition with a high concentration of the desired primary and secondary metabolites and less environmental impacts. Biotechnology applied to the production of natural food ingredients from plant cell cultures offers higher safety, availability and standardization levels over more conventional processes using open field cultivation. Furthermore, this technology is fully eco-friendly and non-GM, and allows the availability of active substances even from protected or endangered plants, without affecting the delicate natural ecosystem balance and biodiversity.

Although the production of plant secondary metabolites as food ingredients (colorants, antioxidants, etc.) using plant cell cultures have been highlighted for the past decades, these processes require identifying and extracting particular compounds. By using whole cells according to the present invention a more cost effect and novel route for a functional food source is provided. Since plant cells contain many kinds of essential and valuable nutrients that are required for human health (e.g., protein, carbohydrate, fat, fiber, vitamin minerals). Whole plant cell foods can satisfy the above demands, leading to lower environmental impacts and higher nutritive values.

We claim:

1. A method for making a food product or ingredient, comprising:
providing a culture media including a carbohydrate source of energy;
heterotrophically propagating an undifferentiated plant cell in the culture media in a bioreactor;
harvesting the undifferentiated heterotrophic plant cells from the culture media;
drying, and/or milling, and/or pasteurizing the harvested plant cells to produce a food ingredient.

2. The method of claim 1, wherein harvesting the undifferentiated plant cells includes washing the cells.

3. The method of claim 2, wherein the plant cells are substantially free of cell culture.

4. The method of claim 3 further comprising drying the plant cells in a drum dryer or a freeze dryer.

5. The method of claim 1, wherein the heterotrophic plant cells include grain cells, vegetable cells, and/or fruit cells.

6. The method of claim 1, wherein the heterotrophic plant cells include a grain selected from oat, quinoa, millet, teff, buckwheat, sunflower, Jerusalem artichoke, barley, rice, rye, sorghum, wheat, spelt, emmer, einkorn, kamut, maize; a vegetable selected from garlic, onion, celery, asparagus, beet, cabbage, broccoli, kale, cauliflower, canola, mustard, pepper, chicory, cucumber, squash, carrot, yam, sweet potato, lettuce, lentil, tomato, avocado, legumes, mustard, potato, spinach; and/or a fruit selected from pineapple, tea, papaya, carob, orange, grapefruit, lemon, lime, coconut, coffee, melon, fig, Strawberry, apple, mango, banana, plantain, date, peach, cherry, almond, plum, pear, raspberry, blackberry, cocoa, berry, and/or grape.

7. The method of claim 1, wherein the heterotrophic plant cells include A food product as in any of the foregoing claims, wherein the heterotrophic plant cells include Avena sativa, Chenopodium spp., Echinochloa spp., Pennisetum spp., Setaria spp., Panicum spp., Eleusine spp., Paspalum spp., Eragrostis tef, Fagopyrum esculentum, Helianthus sp., Oryza spp., Secale cereal, Sorghum spp., Triticum spp., Zea mays, Allium spp., Apium graveolens, Asparagus officinalis, Beta vulgaris, Brassica spp., Capsicum spp., Piper spp., Pimenta spp., Cichorium intybus, Cucumis sativus, Cucurbita spp., Daucus carota, Dioscorea sp., Ipomoea sp., Lactuca sativa, Lens culinaris, Lycopersicon spp., Persea americana, Phaseolus spp., Vigna spp., Glycine max, Arachis hypogaea, Pisum spp., Sinapis alba, Solanum tuberosum, Spinacia oleracea, Ananas comosus, Camellia sinensis, Carica papaya, Ceratonia siliqua, Citrus sp., Cocos nucifera, Coffea spp., Cucumis spp., Ficus spp., Fragaria spp., Malus domestica, Mangifera spp., Musa spp., Phoenix dactylifera, Prunus spp., Pyrus spp., Rubus spp., Theobroma cacao, Vaccinium spp, Viburnum spp., Vitis spp., Bixa orellana, Camellia sinesis, Cinnamomum spp., Crocus Sativus, Curcuma longa, Elaeis guineensis, Humulus lupulus, lavandula spp., Mentha spp., Ocium basilicum, Origanum spp., Petroselinum spp., Rosa spp., Rosmarinus officinalis, Saccharum spp., Beta vulgaris, Salvia spp., Thymus spp., or Vanilla spp.

8. A food product suitable for human consumption, comprising:
a heterotrophic plant cell component including dehydrated, undifferentiated heterotrophic plant cells isolated from cell culture and mixed with a food component.

9. The food product of claim 8, wherein the food component is selected from grain, diary, fruit, vegetable, meat, or dessert.

10. The food product of claim 8, wherein the food component is selected from milk, yogurt, cheese, vegetables, beans, eggs, bread, cereal, pasta, or flour.

11. The food product of claim 8, wherein the heterotrophic plant cells include a flavor, fragrance, or colorant type plant cell selected from annatto, tea, cinnamon, saffron, turmeric, palm, hops, lavender, mint, basil, oregano, marjoram, parsley, rose, rosemary, sugar, sage, thyme, vanilla.

12. The food product of claim 8, wherein the heterotrophic cells comprise at least 1% by weight and less than 80% by weight of the food product.

13. The food product of claim 8, wherein the heterotrophic cells comprise at least 10% by weight and less than 30% by weight of the food product.

14. A food ingredient, comprising:
a dry biomass comprising heterotrophic plant cells, the plant cells comprising undifferentiated whole cells from cell culture, wherein the biomass includes washed and dried cells, the biomass having a moisture content less than 25%.

15. The food ingredient of claim 14, wherein the heterotrophic plant cells include grain cells, vegetable cells, and/or fruit cells.

16. The food ingredient of claim 14, wherein the biomass has a moisture content of less than 15%.

17. The food ingredient of claim 14, wherein the food ingredient is a flake, flour, or powder.

18. The food ingredient of claim 14, wherein the food component is milled to have a median particle size less than 150 μm.
